(19) United States
(12) Patent Application Publication
(10) Pub. No.: US 2007/0174076 A1
(43) Pub. Date: Jul. 26, 2007

(54) System and method for providing real-time access of real estate property transaction information and status via voice communication networks

(76) Inventors: Crystal Kord, San Clemente, CA (US); John Nguyen, Irvine, CA (US); Kenneth Stockman, Fountain Valley, CA (US); Jacob Wills, Los Angeles, CA (US)

Correspondence Address: PATENT GROUP;C/O DLA PIPER US LLP, 203 N. LASALLE ST., SUITE 1900, CHICAGO, IL, 60601, US

(21) Appl. No.: 11/342,133

(22) Filed: Jan. 26, 2006

(51) Int. Cl. G06Q 99/00

(52) U.S. Cl. 705/1

(57) ABSTRACT

A system and method for providing real-time access of real estate property transaction status via voice communication networks. The system and method provides real estate professionals and their clients mobile access to the most recent escrow and title information of their respective real properties transactions via a voice driven interface.

### BACKGROUND OF THE INVENTION

The present invention generally relates to computer and telecommunication technologies and, more particularly, to database access and voice communication technologies.

Real estate professionals represent the epitome of the modern mobile workforce. Every day, agents are in the field with their clients, and they are always on the move. They need the next generation of mobile computing tools for the real estate professionals to access the escrow status and title information of the real estate property transactions that they are involved in. Real estate professionals including agents and escrow officers, and the prospective buyers and sellers of real estate properties, all require tools that are simple to use and quick to react to the information of the real property escrow and title status in particular transactions.

Conventionally, in order to access the escrow status or title information data, the average realtor needs to call and talk to an escrow or title officer, and request information in hard copies. This process is time consuming and depends on the availability of the escrow or title officer.

Alternatively, the realtor may sit down at an Internet-connected computer, log in to the website of the escrow or title officer, and search for the information, if it is available on-line. This process requires the realtor to be in his or her office with an Internet connection.

Other circumstances often arise that present the same challenges for the real estate professionals and their clients. It would be desirable to be able to call into an automated system and get the escrow status or title information directly over the telephone and even receive notifications via automated phone calls or text messages without ever sitting in front of a computer.

It is therefore desirable to provide real estate professionals and their clients with voice access to a computer system wherever and whenever they need it, through which they simply dial and talk, and which runs executable computer programs that can provide on-the-spot information to answer any inquires about the escrow status or title information of real estate property transactions.

Accordingly, it is an object of the present invention to provide a mobile productivity tool that satisfies the need for the parties involved in real estate transactions to obtain real-time real estate property transaction information and status.

It is another object of the present invention to provide a mobile productivity tool that allows real estate professionals to service their clients more effectively by providing their clients with up-to-date and accurate information on real estate property transaction status.

It is another object of the present invention to provide a mobile productivity tool that is simple to use and will not require the user to overcome any learning curve.

It is still another object of the present invention to provide a mobile productivity tool that is extremely cost-effective to real estate professionals, escrow operations, title insurance operations, and all participants in a transaction.

It is still another object of the present invention to provide a mobile productivity tool that is an extendable foundation for other products and services that real estate professionals may be able to use in the ever-changing marketplace of mobile productivity tools.

### SUMMARY OF THE INVENTION

The present invention is a mobile productivity tool implemented through a comprehensive system and method that is simple to use and provides accurate real-time real estate property transaction information and status through its voice access and proactive notification features. The system and method of the present invention provides a speech-enabled, telephone interface to a real estate property transaction management program that provides its user with a significant advantage by enabling a unique, more usable mobile interface that supports the goals of enhanced process automation, efficiency, and convenience to all parties involved in a real estate property transaction.

The voice enabled interface frees users from the constraints of the traditional Internet paradigm, enabling them to initiate, access, and manipulate tasks and information whenever and wherever it is most appropriate, convenient, and productive. The voice enabled technologies can extend that affinity marketing value to the transaction participants in the field, in the office, or wherever they may be at the time.

The present invention includes an “escrow” application program that provides real estate property transaction status designed to redesign the way the escrow agent interacts with the buyer or seller's agent and their respective clients. The ability to automate the process and provide greater control increases the productivity of the escrow office and results in greater potential revenue and margins.

The “escrow” program also provides a new and innovative product that both title and escrow companies can introduce to their customers. Both title and escrow sales representatives regularly search for unique products to introduce to the real estate agent as a way to add value to their relationship. The present invention provides a tool that strengthens the relationship between the agents and the title/escrow sales representatives.

The “escrow” program further provides increased efficiency to the escrow and title companies. By providing a service that allows the agent and client to check on the status of their escrow without the need to physically speak to an escrow agent, the time and resources required by escrow officers to communicate simple updates are substantially reduced. Speech and telephonic capabilities allow users to initiate orders and information requests right when they need them, no matter where they may be. The system accelerates the “sales cycle” by bringing in the related revenues more quickly, lowering costs and improving customer satisfaction. The proactive, “push” notification capabilities of such functionality can reach out and initiate customer interactions as soon as they are required.

For example, when an escrow file is opened by an agent, there are often inaccuracies introduced into the transaction as the result of simple human error in the data entry process. The present invention program can call the clients after the file is opened, read back the basic file creation information, and allow them to correct any problems right there on the spot. This reduces latency in the process and moves transactions through to completion more rapidly. This newly freed time allows the escrow officer to focus on closing files instead of answering questions, providing status, and correcting data entry errors. These efficiency gains can truly increase the revenue potential of the escrow firm by reducing customer service costs.

The present invention also includes a “title” application program which is designed to provide added value to the title representative by enabling them to use a voice interface on a telephone to initiate a title order, check on the status of that order, be alerted upon completion of the order, and even forward the final documents to appropriate parties in the transaction.

This additional market opportunity is established by providing the title representative with three primary benefits. A title order may be initiated from anywhere, as soon as it is requested by a buyer or their agent. This accelerates the revenue event for the title company, effectively making money more quickly and shortening the sales cycle.

The “title” program also provides title representatives a channel to have access to their order status at anytime and anywhere. This benefit improves the efficiency of the title representative's operations by allowing them to proactively address any issues that come up relating to the title order before they become critical problems or a bottleneck in the escrow process. This allows the title representative to provide a superior service to all the parties involved in the transaction. By allowing title representatives to be more responsive, more proactive, and more efficient, the consumers and their agents will benefit and drive additional business to the title representative who facilitated their transaction.

An additional benefit is the ability of the title representative to provide a superior service to all the parties involved in the transaction. By allowing title representatives to be more responsive, more proactive, and more efficient, the consumers and their agents will benefit and drive additional business to the title representative who facilitated their transaction—either as repeat customers or referrals.

The following detailed description of embodiments of the invention, taken in conjunction with the accompanying drawings, provide a more complete understanding of the nature and scope of the invention.

### BRIEF DESCRIPTION OF THE DRAWINGS

FIG. 1 is a block diagram illustrating the hardware and architecture of an embodiment of the system and method of the present invention;

FIG. 2 is a data flow diagram illustrating the main software application modules and architecture in an embodiment of the system and method of the present invention;

FIG. 3 is a data flow diagram illustrating the main functionalities of the Web Interface module of FIG. 2;

FIG. 4 is a data flow diagram illustrating the main functionalities of the Voice Interface module of FIG. 2;

FIGS. 5A-5C are data flow diagrams illustrating the main functionalities of the Scheduler module of FIG. 2;

FIG. 6 is a data flow diagram illustrating the main functionalities of the Listener module of FIG. 2;

FIG. 7 is a flow chart showing the voice interface navigation of an embodiment of the system and method of the present invention;

FIG. 8 is a schematic illustrating the functionality the escrow program of an embodiment of the system and method of the present invention;

FIG. 9 is a flow diagram showing the interactions between an escrow officer and the escrow program of FIG. 8;

FIG. 10 is a flow diagram showing the interactions between a buyer's or seller's agent and their clients and the escrow program of FIG. 8;

FIGS. 11 and 12 constitute a schematic block diagram showing the interactions between any user and the escrow program of FIG. 8;

FIG. 13 is a schematic block diagram showing the auto-notification features of the escrow program of FIG. 8;

FIG. 14 is a schematic block diagram showing the collaboration features of the escrow program of FIG. 8;

FIG. 15 is a schematic block diagram illustrating the functionality of the title program of an embodiment of the system and method of the present invention;

FIG. 16 is a schematic block diagram showing the interactive features of the title program of FIG. 15;

FIG. 17 is an illustrative diagram showing a sample User Log-In screen layout of the present invention application programs;

FIG. 18 is an illustrative diagram showing a sample Home Page screen layout of the present invention application programs;

FIG. 19 is an illustrative diagram showing a sample Update Profile screen layout of the present invention application programs;

FIG. 20 is an illustrative diagram showing another sample Update Profile screen layout of the present invention application programs;

FIG. 21 is an illustrative diagram showing another sample Update Profile screen layout of the present invention application programs;

FIG. 22 is an illustrative diagram showing a sample Validity and Update Data screen layout of the present invention application programs;

FIG. 23 is an illustrative diagram showing another sample Validity and Update Data screen layout of the present invention application programs;

FIG. 24 is an illustrative diagram showing another sample Validity and Update Data screen layout of the present invention application programs;

FIG. 25 is an illustrative diagram showing a sample Web Search screen layout of the present invention application programs;

FIG. 26 is an illustrative diagram showing another sample Web Search screen layout of the present invention application programs.

### DETAILED DESCRIPTION OF THE PREFERRED EMBODIMENTS

Although specific embodiments of the present invention will now be described with reference to the drawings, it should be understood that such embodiments are by way of example only and merely illustrative of but a small number of the many possible specific embodiments which can represent applications of the principles of the present invention. Various changes and modifications obvious to one skilled in the art to which the present invention pertains are deemed to be within the spirit, scope and contemplation of the present invention as further defined in the appended claims.

The hardware, architecture, software and general functionality of a preferred embodiment of the system and method of the present invention will be discussed initially below followed by a more specific discussion of the escrow program and the title program of the preferred embodiment.

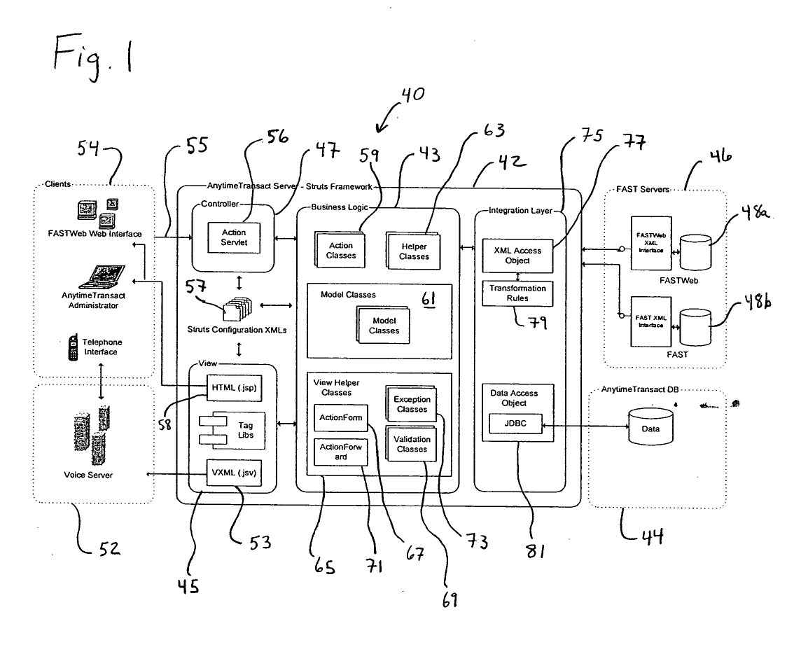

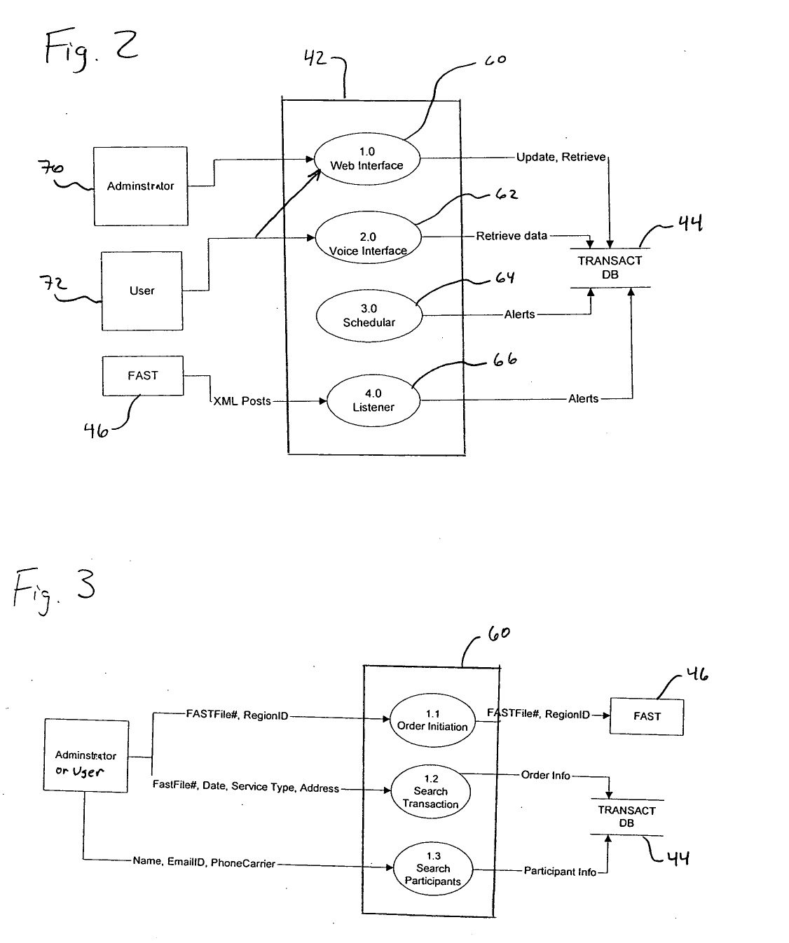

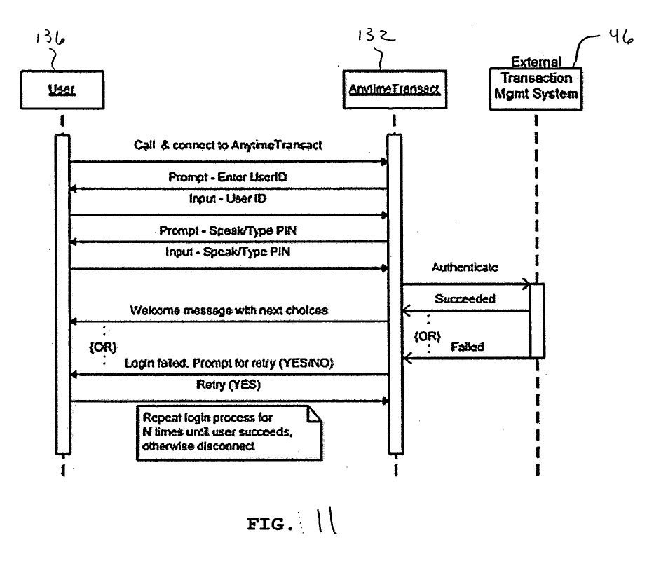

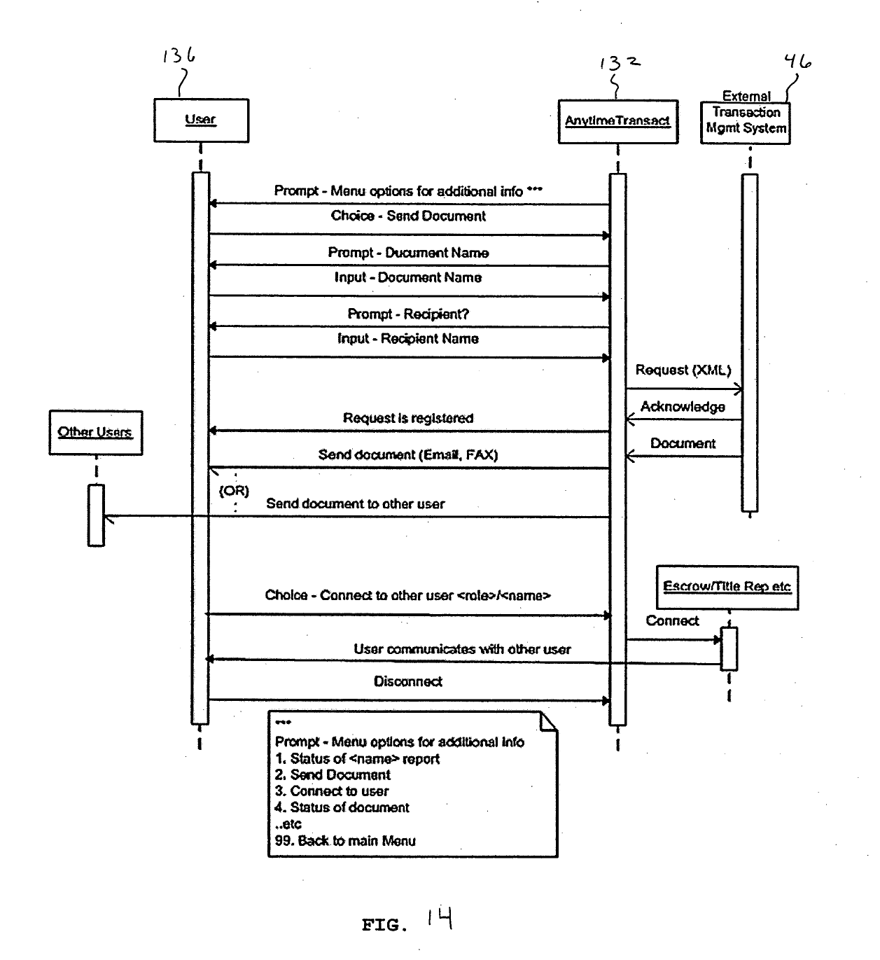

With reference to FIG. 1, an embodiment of the system of the present invention is indicated in general at 40. The system includes a main system server, indicated at 42, upon which a software application is loaded. As will be discussed in greater detail below, with regard to FIGS. 8 through 14 and FIGS. 15 and 16, respectively, the software application includes an escrow program and a title program. The application software may include the escrow program only, the title program only or both the escrow and title programs. The discussion of the general architecture and functionality of the software with regard to FIGS. 2 through 7 applies equally to the escrow and title programs. The main system server and software application preferably are deployed on IBM Websphere Application Server with an IBM DB2 main system database 44 on the backend.

As illustrated in FIG. 1, the system 40 also includes third party applications or external systems 46 with which the main system server and software communicate for required information. The external systems illustrated in FIG. 1 include transaction databases 48a and 48b. Examples of appropriate external systems include the FAST and FASTWeb systems developed and owned by The First American Corporation of Santa Ana, Calif.

The system also features a voice server 52, which is preferably an IBM Voice Server with a supporting platform for voice specific functionality. The voice interface of the system, indicated at 53 in FIG. 1, has been designed using VXML version 2.0. The user can access the voice interface by dialing a toll-free number. An VXML file is mapped to a phone number on the voice server 52.

As indicated at 54 in FIG. 1, a number of clients use the system 40 and thus interact with main system server 42. These clients include users such as real estate agents and escrow officers, which may access the system either by telephone via the voice server 52, or through the Internet using an Internet interface. In addition, the system administrator is a client that accesses the system through the Internet. These individuals are provided as examples only and other individuals may be given access to the system as well.

The main system server 42 preferably features an architecture based on the Struts Framework architecture. As is known in the art, the Struts Framework is a standard for developing well-architected Web applications and is based on the Model-View-Controller (MVC) design paradigm, distinctly separating the three levels of Model, View and Controller. The Model level (43 in FIG. 1) handles the business logics. The View level (45 in FIG. 1) handles displaying of the data to user and the Controller level (47 in FIG. 1) handles routing of the application flow.

With reference to FIG. 1, all incoming requests 55 are intercepted by the Action Servlet Controller 56. The Struts Configuration XML files 57 are used by the Controller to determine the routing of the flow. This flows consists of an alternation between two transitions: From View 45 to Business Logic (or Model) 43 and From Business Logic 43 to View 45. For the former, From View to Business Logic, a user clicks on a link or submits a form on an HTML or JSP page 58. The controller 47 receives the request, looks up the mapping for this request, and forwards it to the Action Classes 59. The Action Classes in turn calls the Model Classes 61 service or function. For the latter transition, From Business Logic to View, after the call to an underlying function or service returns to the Action Classes, the action forwards to a resource in the View layer 45 and a page is displayed in a web browser.

Action Classes 59 therefore act as bridges between user requests and business services. Action Classes process a request (e.g. add or delete a participant from an escrow order) and return an object that identifies the next component to invoke from the Model Classes 61 for services.

Helper Classes 63 provide utility functions to the Business Logic such as generating alert messages, providing messages log capability and parsing XML requests.

Model Classes 61 provide the business logics and are invoked by Action Classes. Model Classes provide both DAO (Data Access Object) and VO (Voice Object). These objects include alert, communication method, document, order, participant, phone carrier, property, region, role, state, status, task and transaction.

The Business Logic also includes View Helper Classes 65. These include an ActionForm that acts as a firewall between forms (web pages) and the application (actions). It calls Validation Classes 69 to validate user input before return an ActionForward object 71 that identifies the next component to invoke. If user input is invalid, Exception Classes 73 are invoked for error handling.

The Integration Layer 75 handles the communication between the Business Logic 43 with the external servers 46 and the main system database 44. All communication between the Business Logic and the external servers 44 are handled by the XML Access Object 77 with pre-defined Transformation Rules 79. All communications between the Business Logic and the main system database are handled by the Data Access Object 81 through JDBC (Java Database Connectivity).

An overview of the software application modules of the main system server 42 is presented in FIG. 2. More specifically, the software application includes a Web Interface module 60, a Voice Interface module 62, a Scheduler module 64 and a Listener module 66. As noted above, the Web Interface 60 is available to the system administrator 70 and to users 72 of the system. The Voice Interface 62 is available to the users 72 of the system as well. The Scheduler module 64 is responsible for dispatching alerts from the system to users. A Listener module 66 listens to the alerts posted by external systems 46. Such alerts may be generated, for example, by an escrow or title order initiation and status alerts posted by the external systems 46. As illustrated in FIG. 2, all four modules communicate with the main system database 44.

The details of the Web Interface module 60 are illustrated in FIG. 3. The Web Interface module provides three major functionalities or processes that may be used by the administrator or users: Order Initiation, Search Transaction and Search Participants.

The Order Initiation process fetches data from the external system 46 and updates the main system database 44 with escrow or title order information. An external system file identification number and region ID preferably are passed during the process to the external system 46 to retrieve the order information. The administrator or user can then setup callouts for that order which includes generating order initiation emails and phone calls to all the participants involved in the order.

The Search Transaction process searches the escrow or title orders of the main system database 44 and provides a list of orders to the administrator or user. The transactions can be searched by giving search criteria like the external system file identification number, order date, service type (title or escrow) and other such criteria. The displayed orders can be deleted, or edited to add new participants in the order or to delete participants from order.

The Search Participant process searches for specified participants in the main system database 44. Search criteria like name, email address and phone carrier can be given. The displayed list of participants can be edited or deleted.

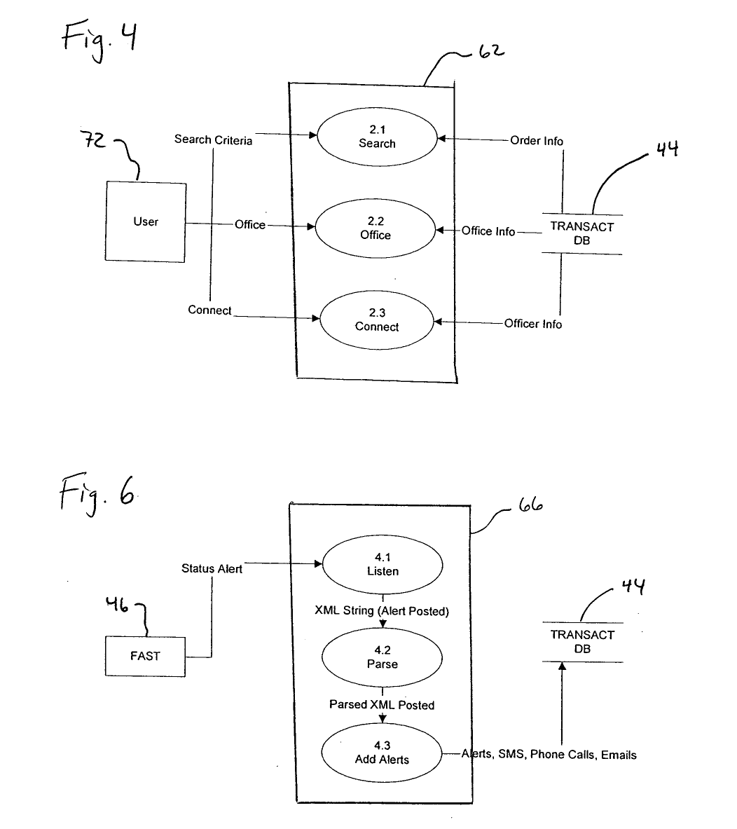

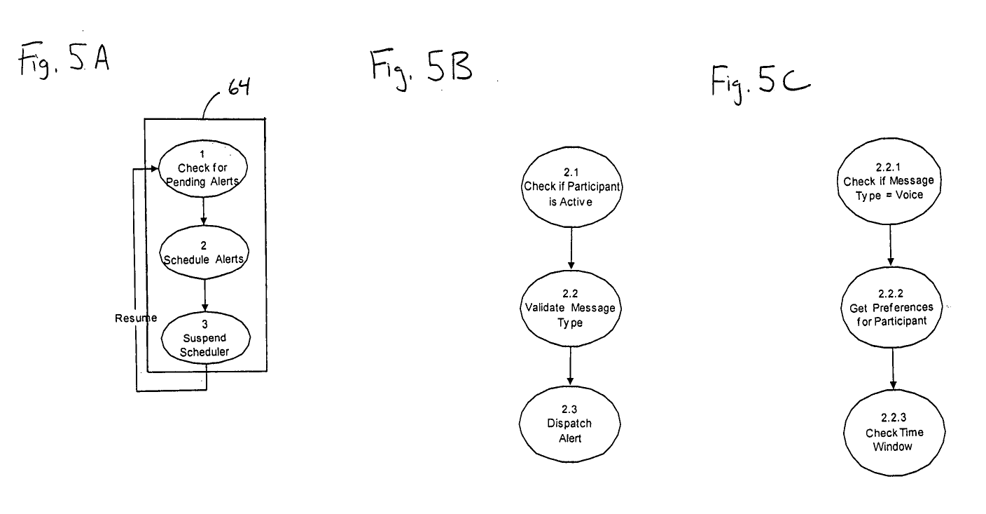

With reference to FIG. 4, the Voice Interface module 62 lets a user 72 search for title or escrow orders on the main system database 44 that the logged in user is associated with. In other words, the search feature searches for orders associated with that particular user. These orders can be searched by external system file identification number or by the property address. The searched order can then in turn be queried for task, documents and participants involved.

As illustrated in FIG. 4, the Voice Interface module also lets the user listen to office contact and location information about, for example, the escrow officer. The user can also say “Connect” and automatically get connected to the escrow officer for more details.

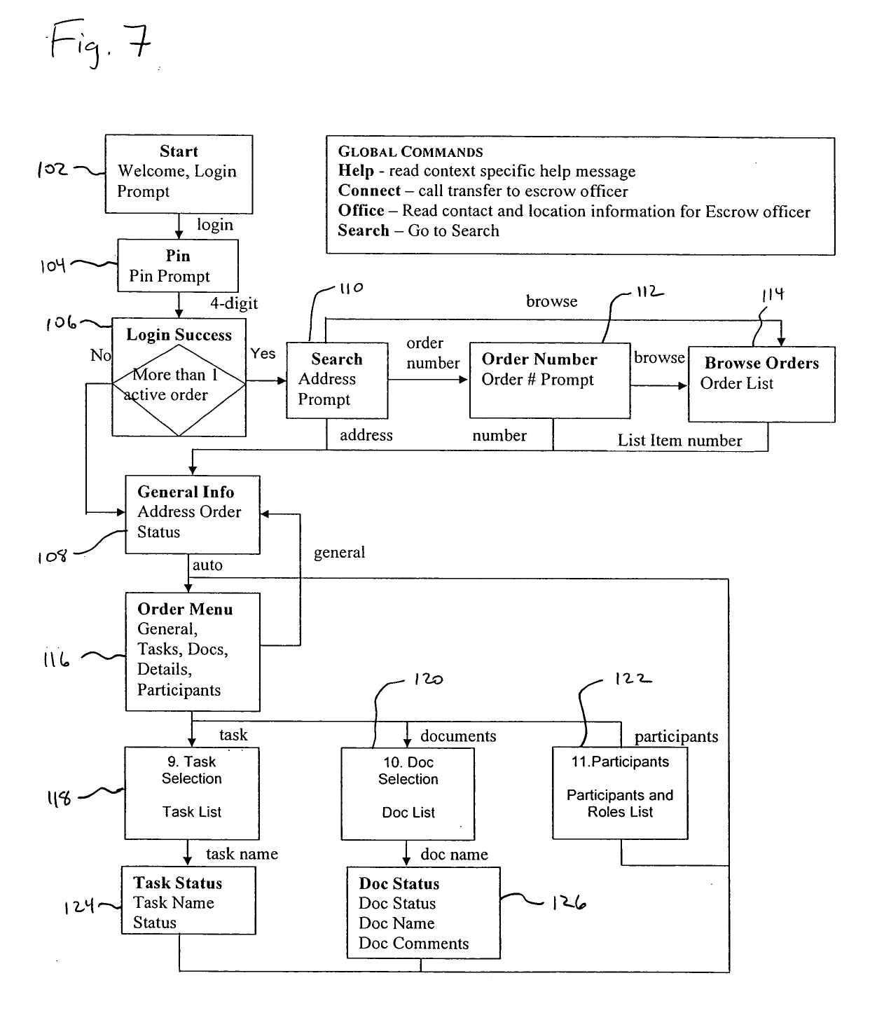

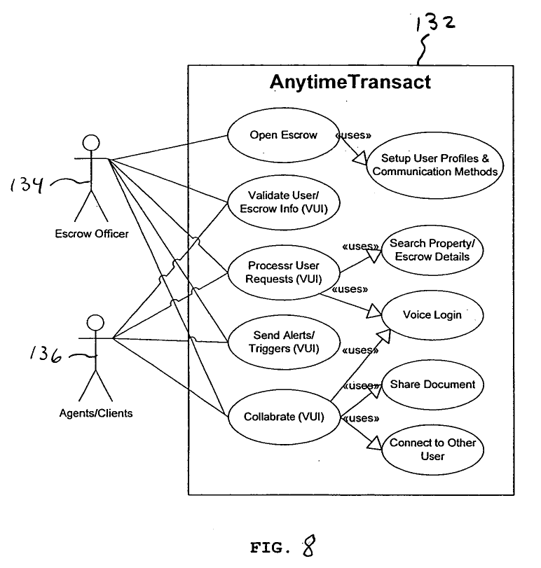

The Scheduler module, 64 in FIGS. 2 and 5A, is responsible for checking pending alerts on the main system database 44 (FIG. 2). As illustrated in FIG. 5A, if there are alerts to be processed, it schedules alerts to be sent to participants. The Scheduler then goes into the suspend or sleep mode (sleep time is configurable) and waits for new alerts to be arrived for processing. As illustrated in FIG. 5B, the Schedule Alerts process checks to see if a participant is active. If the participant is active, it validates the alert message type (i.e. Email, SMS or Voice) and dispatches the alert to the participant. As illustrated in FIG. 5C, the Validate Message Type process checks if the message type is Voice. If the message type is Voice, it gets the participant's call time preferences, and checks the time window before dispatching the voice alert.

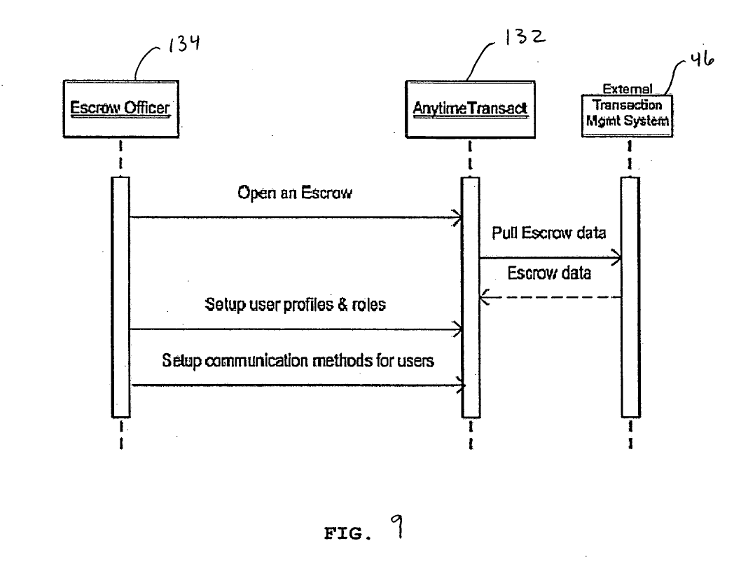

The Listener module, 66 in FIGS. 2 and 6, is accessible by using a specific URL. An external system (46 in FIG. 6) posts alerts to this URL. The Listener module accepts the posted alert XML and then parses it into a pre-define task format. The parsed alert (Email, SMS or Phone Call) is then stored in the main system database (44 in FIG. 6) for later processing by the Scheduler module 64 (FIGS. 2 and 5A-5C). The posted alert XML assumes to be any of the following six tasks: HUD Available, Lender Funds Received, Figures/Instructions, Schedule Closing/Signing, Assemble and Distribute Title Product or Message Board.

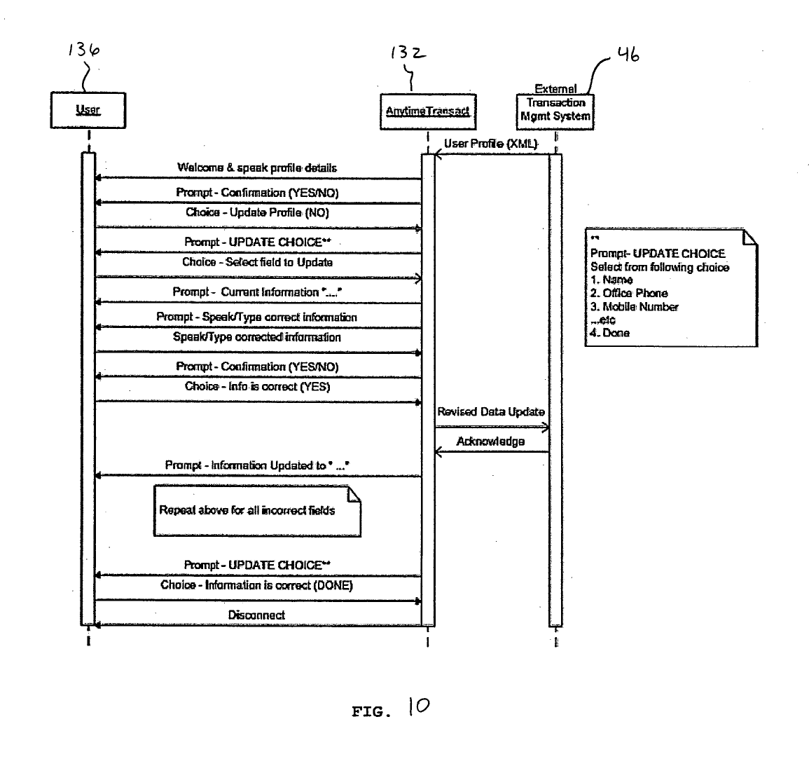

The participants of an order use the voice server (52 in FIG. 1) and voice interface (53 in FIG. 1) to query the details of their orders. A flow chart of the voice interface navigation is presented in FIG. 7. The voice interface identifies the user by a Login ID, PIN pair. With reference to FIG. 7, once the user input matches one of the system Login ID's 102, the user is prompted for a four digit PIN 104. This PIN can be spoken or entered via the phone keypad. Only a four digit (for example) PIN is accepted as a valid input. Built-in grammar “digits” supported by VSML 2.0 can be used to valid the PIN input from the user.

The Login ID and PIN are then submitted to an “action”. The action authenticates the user. If the authentication fails, the User is prompted to speak the LoginID and PIN. The user is given a maximum of three chances to authenticate. If the authentication fails after three attempts, the session is terminated.

Once the User is authenticated 106, the system fetches the latest data from external systems (46 in FIG. 1). As the fetching of the latest data from the web service will result in some delay, some audio is played in the background. The system then finds all the orders associated with the user that has logged in. If the user is not associated with any order, the user will be informed so. Such a user can then connect to the Escrow Officer, or get the escrow office contact and location information or ask for system Help.

If the user has only a single order associated, the system first reads out the general information for that order 108. This general information includes the order number, open date, status and number of documents.

If the user has more than one order associated, the user is prompted to search for the order 110. The system searches for an order using the following criteria:
The address or the street name of the Property associated with that order
The Order Number
   More specifically, the user can say the address of the property associated with that order. The user alternatively can search by giving an order number 112.

Once the user selects a single order 114, the general information for that order is provided 108. The user is also presented with an order menu 116 through which he or she can also query the system for tasks 118, documents 120 and participants 122.

The user selects tasks 118 by saying “Tasks” or “Task Status.” An order is assumed (at this point) to be associated with the following six tasks, which are presented on a task list:
HUD Available
Lender Funds
Closing Schedule
Title Product
Message Board
Figures
   The user is next prompted to select any of the six tasks.

When the user selects a task 124, the following information about the task is read out to the user:
Task Status (Depending upon the Start and End Date)
Start Date (If available)
End Date (If available)
Comments (If available)
   The task status is based on the Start Date and the End Date of the Task.
If the task does not have any Start Date associated, the task is assumed not to be initiated and its status is not initiated
If the Task has Start Date with no End Date, the status is “In Progress”
If the Task has both Start and End Date, the status is “Complete”

As there can be more than one document associated with the Order, when documents 120 is selected, the system reads out the document name and asks the user to key-in or say the number associated with that document.

Once the user selects a particular document 126, the following information of the document is read out:
The document name
The status of the document
The date on which it was last modified

If participants 122 is selected, the system reads out the participants associated their roles in the Order.

“The Escrow Officer is <EOName>”

“The Buyer is <BuyerName>”

“The Buyer Agent is <BAName>”

“The Seller is <SellerName>”

“The Seller Agent is <SAName>”

“The Lender is <LenderRepName>”

No input is expected from the user here.

If the user says “search” at this point, he or she is given the options for searching an order either by
Address
Order Number
List

The user is given the following anytime commands:
Help
Office
Connect
Back
Goodbye
   Each of these will be discussed below.

The user can say “help” at any time to get help regarding the system. This help may either be a live individual or may be an automated help system. Such systems are known in the art.

The user can say “office” at any time to get the office contact and location information of, for example, the Escrow Officer for that order. Once the office contact and location information has been read out, the user is asked to say either back or search to do any further processing.

The user can say “connect” at any time to connect to the Escrow Officer or other individual associated with that order. Once the call is placed to the associated office, the current session of the user will be terminated and the user will be connected to the office.

The user can say “back” at any time to be taken to the previous menu.

The user can say “goodbye” at any time to quit the application.

At any point of time if the user does not say anything for a specified period of time, the system preferably will say:
“I'm sorry, but I did not hear you.”
   If the user input does not match the grammar for that particular input, the system will say:
“I'm sorry, but I did not understand you. Could you repeat that please?”

Whenever any new order is being initiated, confirmation messages are communicated to the participants through outbound calls. The call reads out to the user the following details:
Order Number
Property Address
Role in the Order
Contact Information (Address, Phone Number, Email Address)
“PIN”
System toll-free number

Whenever the system is posted with a change in the status of one of the six tasks, an outbound call is generated.

Referring to FIGS. 8 through 14, there are shown steps of the “escrow” program 132 of the system, which is loaded on the main system server (42 in FIG. 1) and provides real-time escrow status and information of a real estate property transaction through its voice access and proactive notification features.

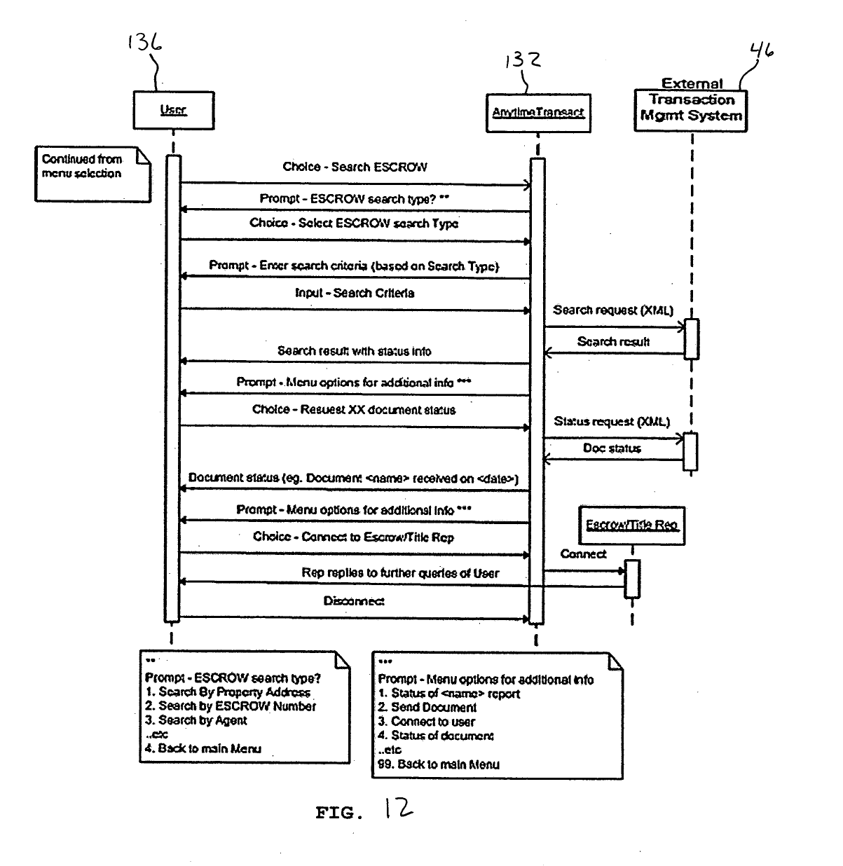

As illustrated in FIGS. 8 and 9, according to the present invention system and method an escrow officer 134 initiates the process using the web interface of the main system server (42 in FIG. 1). He pulls required data from an external system (46 in FIG. 1) and sets up the profiles of a particular real estate transaction.

At this time, the escrow officer also configures via an online interface how they would like the “escrow” program to interact with the people involved in the deal. This includes their preferred contact information for this purpose, their role(s) in the transaction, what communication channels they desire, and when they are willing to receive the communications.

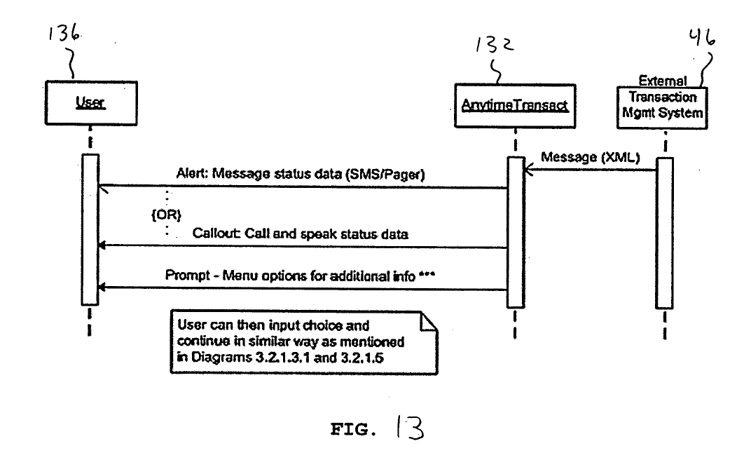

Referring to FIGS. 8 and 10, following the initiation of escrow and setup of the users involved in the transaction 136, the first function of the “escrow” program is to call the users and confirm that the information relating to them in the system is correct via an automated, speech recognition interface. If any of the information in inaccurate, the user can simply speak the correct information in order to update the transaction records according. This not only confirms for the participants that the process has been initiated, but it also improves efficiency by catching data recording and entry errors before they cause problems at more critical stages in the transaction.

Referring to FIGS. 8, 11 and 12, as the transaction proceeds, the participants may often want to know the status of the overall transaction or a particular milestone. With the “escrow” program, the agents, their clients, the title representative, or the lender can simply dial the toll-free phone number, speak their user name and password, and “escrow” program responds. The users simply input the property address or escrow order number to access the current transaction information, and then they simply speak the name of the document of interest (e.g., termite report, termite clearance, appraisal, loan documents, etc.). The “escrow” program then responds with the status of the queried document, such as “Received [date],” or “Not Available” (meaning it has yet to be received), or other status as provided by the management systems.

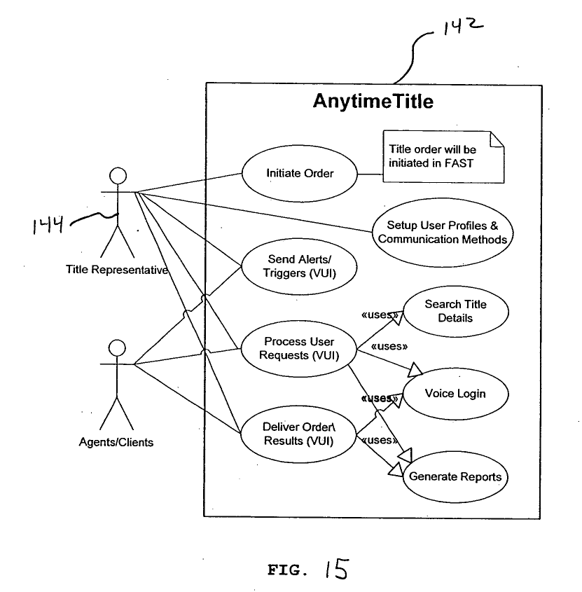

Referring to FIGS. 8 and 13, the “escrow” program can also be configured to automatically notify participants when the status of a relevant milestone or document changes. Via telephone call, email, or text message, the users can receive updates on their transaction as soon as something changes, so they always know exactly where their deal is in the process.

This proactive alerting capability can even be extended to notify participants about the status of a particular step prior to its due date. For example, a buyer may be notified 24 hours before a payment is required to another participant in order to reduce the risk of that milestone delaying the transaction.

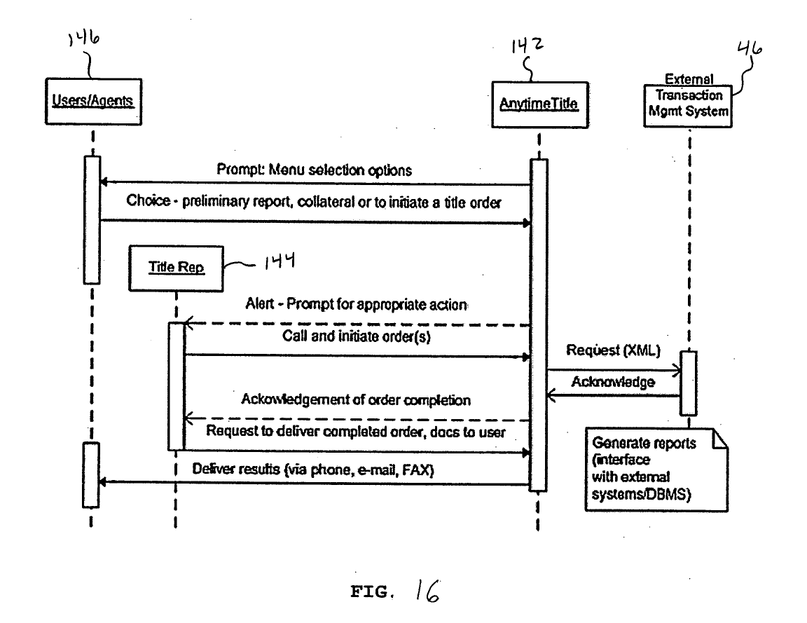

Referring to FIGS. 8 and 14, the speech enabled interface of the “escrow” program can be utilized as an access channel for documents or in-person communications. For example, when a title representative calls the “escrow” program to check the status of particular document required for the transaction, they could also request that a copy of that document be forwarded to themselves or another participant for verification or filing in their records. The system would then automatically email or fax the document to the appropriate person(s).

In another example, a seller who has called the system to check on the status of an overdue milestone could simple say “Call Escrow” and the “escrow” program would directly connect them to the escrow officer in order to discuss and resolve the delay.

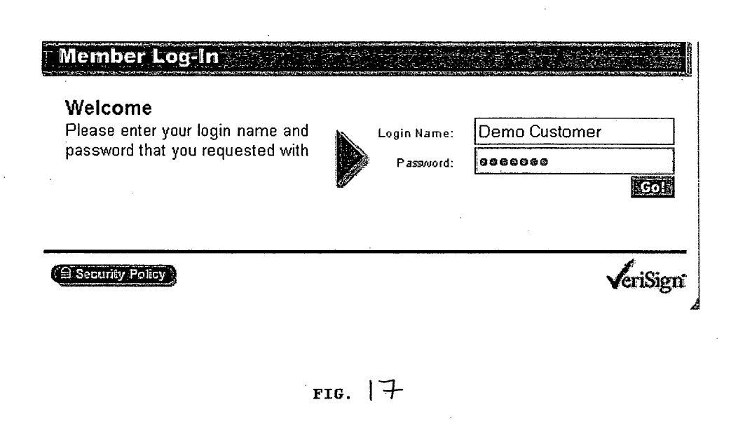

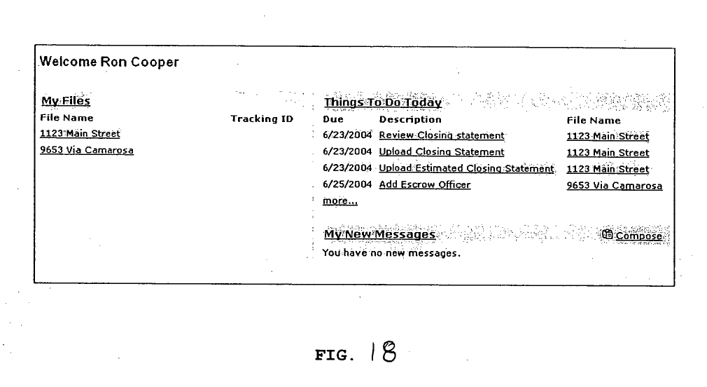

Referring to FIGS. 15 and 16, there are shown the steps of the “title” program 142 of the system, which is loaded on the main system server (42 in FIG. 1) and provides real-time title status and information of a real estate property transaction through its voice access and proactive notification features.

As illustrated in FIGS. 15 and 16, the user group of the “title” application program of the present invention system and method is primarily composed of title representatives 144 who initiate orders and delivery of products and services during the pre-escrow and escrow processes.

A customer may need a preliminary title report prior to making an offer, or an agent may need to initiate an emergency title order in order to keep a deal from falling out of escrow. Wherever they are, the title representatives can then call the “title” program and initiate the order right away, responding to their customer's need as if that agent was their only customer. The title representative can call the “title” program from any telephone, and simply speak to navigate a menu system of available products and services. They then input via speech a few basic data points required for the product order, and the system initiates that order process with the appropriate internal and external systems 46. The process comes to completion with the title representative using a speech recognition interface on the telephone to initiate delivery of a completed order, either in person in order to gain the “face time” benefit or via email or fax in order to achieve the necessary timetable.

The following descriptions are further provided to summarize certain functionality previously mentioned, along with illustrative screen displays of the various user interfaces of the present invention program.

1. Voice/Web Interface

The present invention program provides web interface for management systems that do not already provide one, as well as the voice interface for telephone interactions. The web interface covers all functionality whereas voice interface is limited to certain features and is governed by specific business rules. All users are able to avail themselves of the voice interface. The following features are accessible through the voice interface:
User log-in
Receive status alert—Status alerts for different tasks, events, etc.
Update profiles and other data—Update selected fields of various data chunks like Profile etc.
Voice escrow order search
Escrow status detailed information access
Send data: Send message, document etc.
Connect to other users.

2. User Log-In

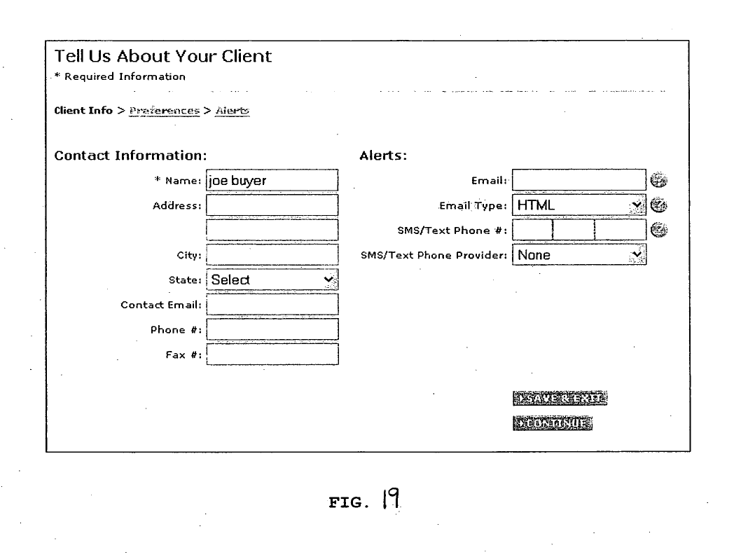

Referring to the sample screen layout shown in FIG. 17, all users use one log-in interface. This validates users and later redirects them to appropriate screens based on their roles. All transactions with the present invention “escrow” program occur over secure connection (HTTPS). All sensitive information (like user credentials) are stored and transported in encrypted format.

3. Home Page

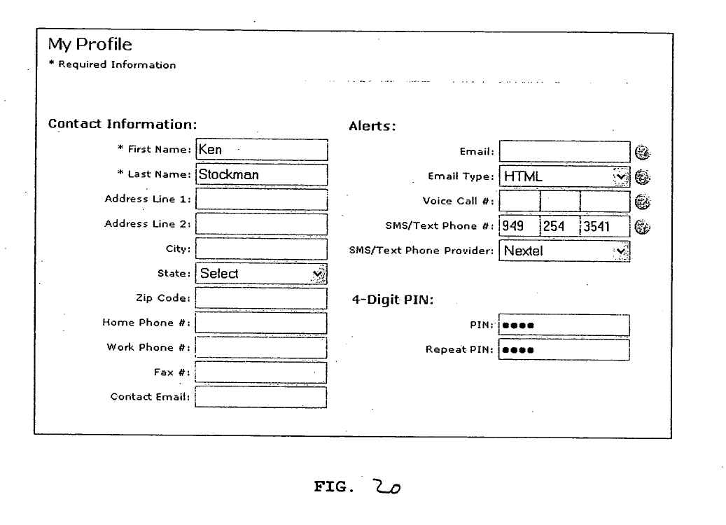

Referring to the sample screen layout shown in FIG. 18, all users see their home page after logging into the present invention “escrow” program. This screen works as a dashboard showing transaction status updates, upcoming tasks, transaction summary, etc.

4. Full Escrow Profile

This process takes as input the initial details about the property and contact information about various individuals involved. Business rules in initial settings specify who can access this functionality.

After integrating with the core transaction management system, the present invention “escrow” program retrieves required property and contact information.

5. Update Profile

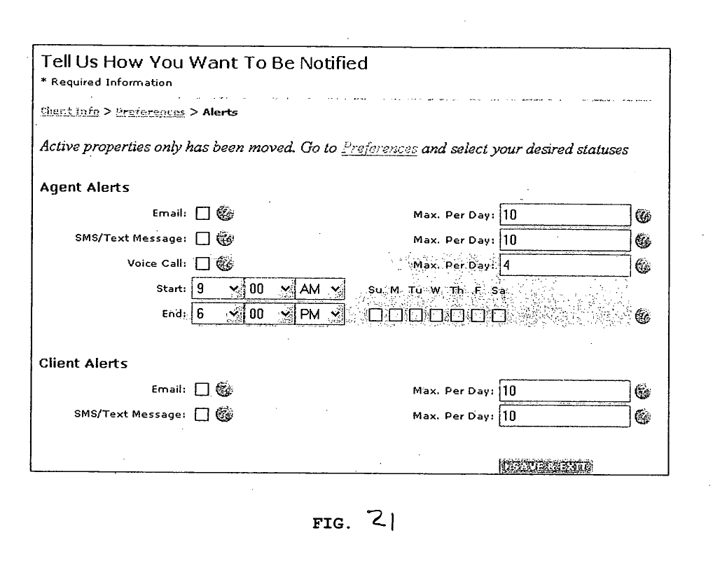

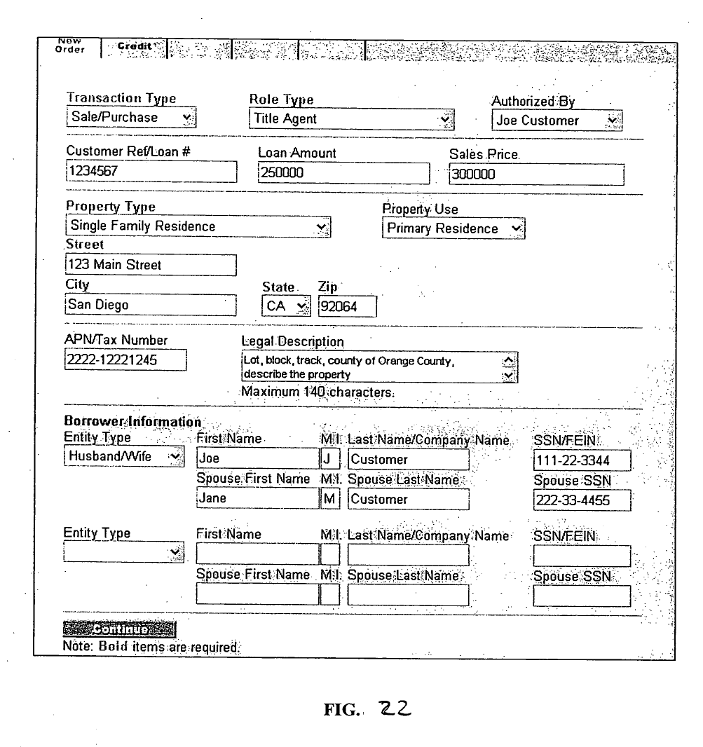

Referring to the sample screen layouts shown in FIGS. 19 through 21, the setup interfaces for the present invention “escrow” program are provided for each of the roles and the functions involved in the escrow process. All users are able to access and modify their profiles. The sample screen layouts are illustrations of analogous configuration interfaces. They are included here to illustrate how proactive alerts and communications can be set up for users according to their preferred contact numbers/addresses, communication channels, and day/time they are available. The setup interfaces for the present invention “escrow” program would be customized to the appropriate roles and functions involved in the escrow process.

6. Validity and Update Escrow File/Title Data

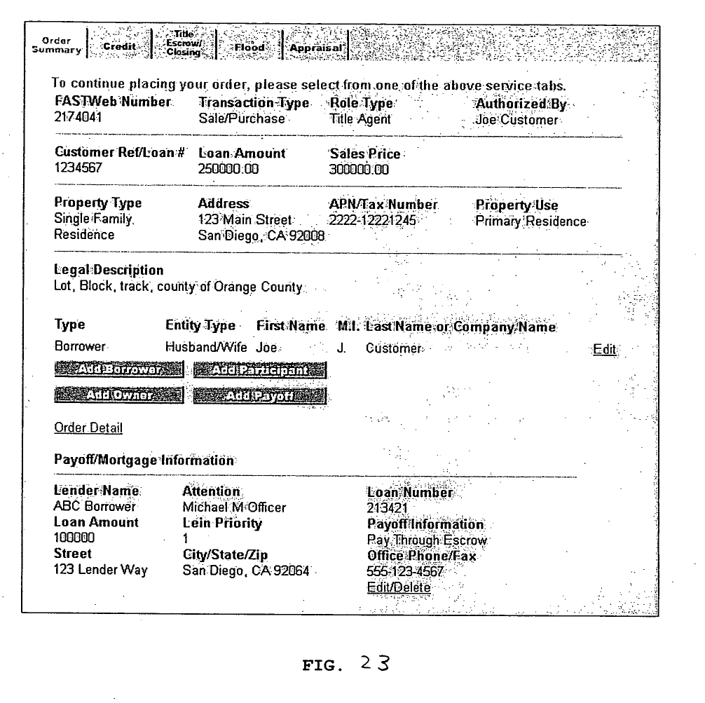

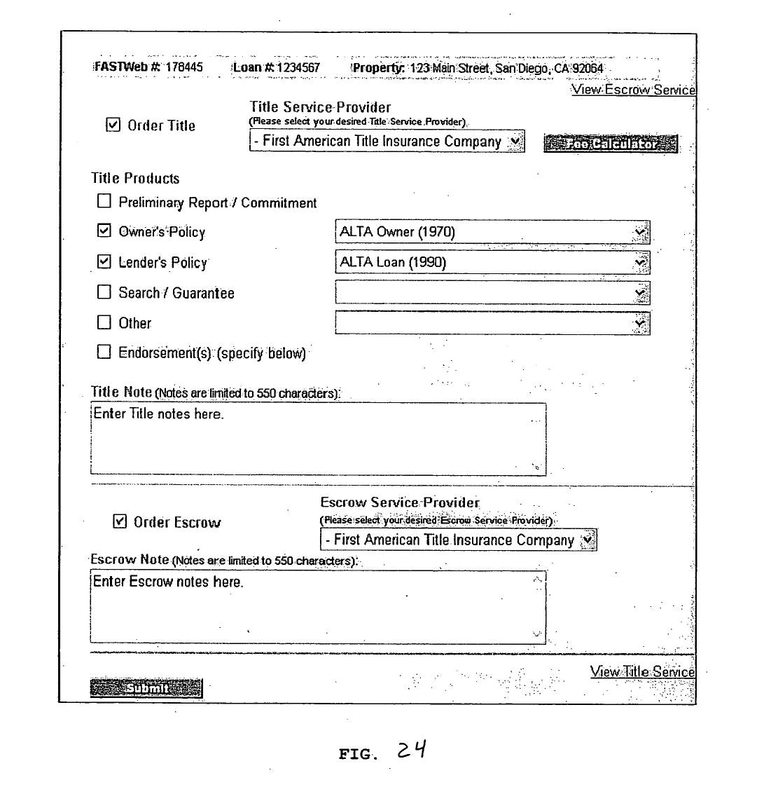

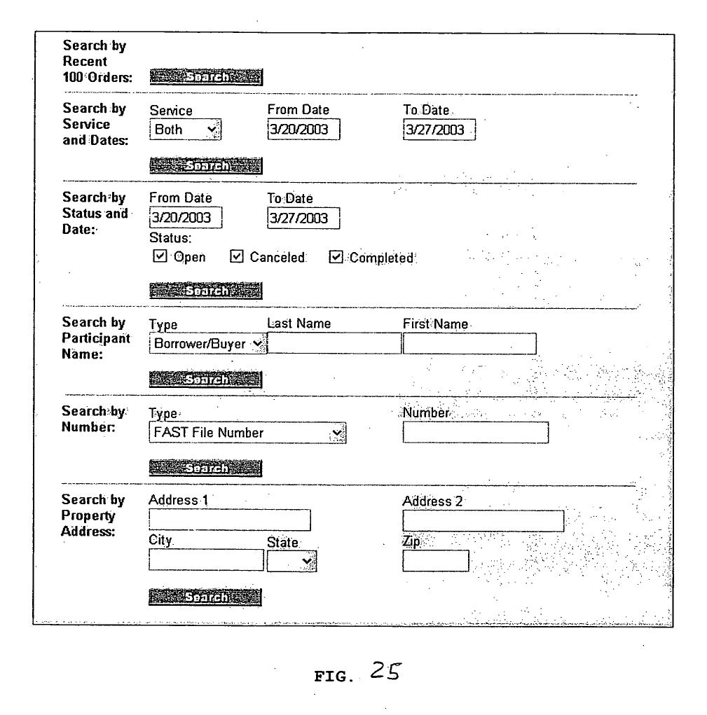

Referring to the sample screen layouts shown in FIGS. 22 through 24, as all property and title data is pulled from an existing database, the present invention program can provide web interface to validate and update that data, including closing date, initial amount, task list for each role (buyer/seller), milestones and corresponding dates, etc. The program can further generate a ready checklist for each of the roles. Task lists for buyer/seller can be selected from this checklist. A facility is provided to add new items to master checklist/task list for a specific deal.

7. Web Search Functions

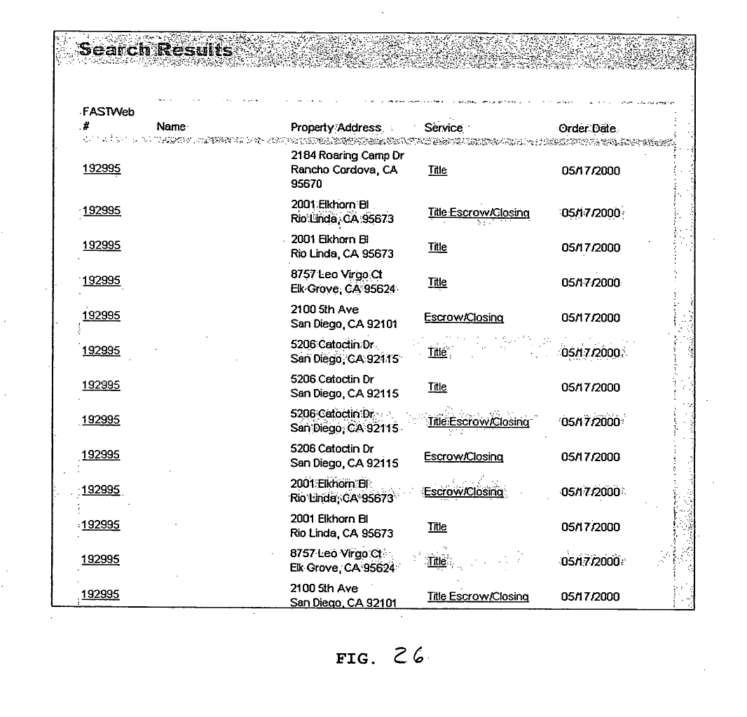

Referring to the sample screen layouts shown in FIGS. 25 and 26, the present invention “escrow” and “title” programs can provide various search options to the users through the web interface, such as:
Search by recent 100 orders;
Search by service and dates;
Search by status and dates;
Search by participant name;
Search by number;
Search by property address etc.

Search options may be shown according to roles and access rights of the users.

8. Voice Activated Search

The present invention program allows its users to simply dial a toll-free phone number, speak their user name and password, and the program will respond. The users input the property address or order number to search the property, and the “escrow” program then responds with the property details and escrow status of the transaction, and the “title” program will respond with the search results of the title orders.

9. Receiving Status Alert

The present invention “escrow” program can also be configured to automatically notify participants when the status of a relevant milestone or document changes. Via telephone call, email, text message or facsimile, the users can receive updates on their transaction as soon as something changes. All these alerts are provided based on the defined roles of respective users.

The Title Representative users of the “title” program are alerted on completion of a title order.

10. Voice Data Update (VUI)

Data containing numbers will be updated at the same time but for text correction, other alternatives such as connecting to the escrow officer or correcting it on a website are used should the nature of the data being input be incompatible with speech recognition input.

11. Send Triggers, Documents and Messages (VUI)

Users may call the “escrow” program to check the status of a particular document required for the transaction. Users could also request that a copy of that document be forwarded to themselves or another participant for verification or filing in their records. The system would then automatically email or fax the document to the appropriate person(s).

The “title” program also forwards documents and collaterals requested by users.

12. Connect to User (VUI)

A user interacting with the voice interface of the “escrow” program can even ask the system to connect to other users. For example, a seller who has called the system to check on the status of an overdue milestone could simply say “Call Escrow” and the program would directly connect them to the escrow officer.

The present invention application programs may further include system maintenance modules to:
Archive users from the system;
Archive canceled/completed escrow and title services (along with the corresponding documents);
Archive notifications and escrow/title history;
Import data from core transaction management system; etc.

The present invention “escrow” and “title” application programs are designed to be used together with other proprietary real estate property transaction management and database programs designed and developed by the assignee of this patent application, including the “Anytime MLS” application programs disclosed in the assignee's co-pending patent application Ser. No. 11/104,371.

Of course the present invention is not intended to be restricted to any particular form or arrangement, or any specific embodiment, or any specific use, disclosed herein, since the same may be modified in various particulars or relations without departing from the spirit or scope of the claimed invention hereinabove shown and described of which the system and method shown is intended only for illustration and disclosure of an operative embodiment and not to show all of the various forms or modifications in which this invention might be embodied or operated. In addition, the present invention has been described in considerable detail in order to comply with patent laws by providing full public disclosure of at least one of its forms. However, such detailed description is not intended in any way to limit the broad features or principles of the present invention, or the scope of the patent to be granted. Therefore, the invention is to be limited only by the scope of the appended claims.

What is claimed is:

1. A method for providing accurate real-time access of real estate property transaction information and status via voice communication networks, comprising the steps of:
a. implementing a software application on a computer system connected to said voice communication networks, said application including an escrow program that allows its users to obtain escrow information and status of their real estate property transactions through said voice communication networks;
b. said application further including a title program that allows its users to obtain title information and status of their real estate property transactions through said voice communication networks;
c. maintaining multiple logical databases containing said escrow and title information and status of said real estate property transactions that are accessible over said voice communication networks;
d. alerting said users of triggering events in escrow and title information and status of said real estate property transactions over said voice communication networks; and
e. providing an Internet based web browser and graphical user interface for accessing of said multiple databases over the Internet.

2. The method in accordance with claim 1, wherein said escrow program comprises the step of setting up user profiles and preferred communication methods.

3. The method in accordance with claim 1, wherein said escrow program comprises the step of opening escrow for said real estate property transaction.

4. The method in accordance with claim 1, wherein said escrow program comprises the step of providing tools for searching detailed escrow information within said databases of said real estate property transactions.

5. The method in accordance with claim 1, wherein said escrow program comprises the step of providing an interface for user voice log-in to access said escrow information and status of said real estate property transactions.

6. The method in accordance with claim 1, wherein said title program comprises the step of setting up user profiles and preferred communication methods.

7. The method in accordance with claim 1, wherein said title program comprises the step of ordering title documents for said real estate property transaction.

8. The method in accordance with claim 1, wherein said title program comprises the step of providing tools for searching detailed title information within said databases of said real estate property transaction.

9. The method in accordance with claim 1, wherein said title program comprises the step of providing an interface for user voice log-in to access said title information and status of said real estate property transactions.

10. The method in accordance with claim 1, further comprising the step of generating reports on said escrow and title information and status of said real estate property transactions.

11. A method for providing accurate real-time access of real estate property transaction information and status via voice communication networks, comprising the steps of:
a. implementing a software application on a computer system connected to said voice communication networks, said application including an escrow program that allows its users to obtain escrow information and status of their real estate property transactions through said voice communication networks;
b. maintaining multiple logical databases containing said escrow information and status of said real estate property transactions that are accessible over said voice communication networks; and
c. alerting said users of triggering events in escrow information and status of said real estate property transactions over said voice communication networks.

12. The method in accordance with claim 11, wherein said application further comprises a title program that allows its users to obtain title information and status of their real estate property transactions through said voice communication networks.

13. The method in accordance with claim 11, further comprising the step of generating reports on said escrow information and status of said real estate property transactions.

14. The method in accordance with claim 11, further comprising the step of providing an Internet based web browser and graphical user interface for accessing of said multiple databases over the Internet.

15. The method in accordance with claim 11, wherein said escrow program comprises the step of setting up user profiles and preferred communication methods.

16. The method in accordance with claim 11, wherein said escrow program comprises the step of opening escrow for said real estate property transaction.

17. The method in accordance with claim 11, wherein said escrow program comprises the step of providing tools for searching detailed escrow information within said databases of said real estate property transactions.

18. The method in accordance with claim 11, wherein said escrow program comprises the step of providing an interface for user voice log-in to access said escrow information and status of said real estate property transactions.

19. A method for providing accurate real-time access of real estate property transaction information and status via voice communicate networks, comprising the steps of:
a. implementing a software application on a computer system connected to said voice communication networks, said application including a title program that allows its users to obtain title information and status of their real estate property transactions through said voice communication networks;
b. maintaining multiple logical databases containing said title information and status of said real estate property transactions that are accessible over said voice communication networks; and
c. alerting said users of triggering events in title information and status of said real estate property transactions over said voice communication networks.

20. The method in accordance with claim 19, wherein said application further comprises an escrow program that allows its users to obtain escrow information and status of their real estate property transactions through said voice communication networks.

21. The method in accordance with claim 19, further comprising the step of generating reports on said title information and status of said real estate property transactions.

22. The method in accordance with claim 19, further comprising the step of providing an Internet based web browser and graphical user interface for accessing of said multiple databases over the Internet.

23. The method in accordance with claim 19, wherein said title program comprises the step of setting up user profiles and preferred communication methods.

24. The method in accordance with claim 19, wherein said title program comprises the step of ordering title documents for said real estate property transaction.

25. The method in accordance with claim 19, wherein said title program comprises the step of providing tools for searching detailed title information within said databases of said real estate property transactions.

26. The method in accordance with claim 19, wherein said title program comprises the step of providing an interface for user voice log-in to access said title information and status of said real estate property transactions.

27. A system for providing accurate real-time access of real estate property transaction information and status via voice communication networks, comprising:
a. a main system server having a software application adapted to be connected to said voice communication networks, said application including an escrow program that allows its users to obtain escrow information and status of their real estate property transactions through said voice communication networks;
b. said application further including a title program that allows its users to obtain title information and status of their real estate property transactions through said voice communication networks; and
c. a database in communication with said main system server and containing said escrow and title information and status of said real estate property transactions.

28. The system of claim 27, wherein said escrow program includes tools for searching detailed escrow information within said database of said real estate property transactions.

29. The system of claim 27, wherein said escrow program includes an interface for user voice log-in to access said escrow information and status of said real estate property transactions.

30. The system of claim 27, wherein the title program includes tools for searching detailed title information within said database of said real estate property transaction.

31. The system of claim 27, wherein said title program includes an interface for user voice log-in to access said title information and status of said real estate property transactions.

32. A system for providing accurate real-time access of real estate property transaction information and status via voice communication networks, comprising:
a. a main system server having a software application adapted to communicate with said voice communication networks, said application including an escrow program that allows its users to obtain escrow information and status of their real estate property transactions through said voice communication networks; and
b. a database in communication with said main system server and containing said escrow information and status of said real estate property transactions that is accessible over said voice communication networks.

33. The system of claim 32, further comprising an Internet based web browser and graphical user interface for accessing of said database over the Internet.

34. The system of claim 32, wherein said escrow program includes tools for searching detailed escrow information within said database of said real estate property transactions.

35. The method in accordance with claim 32, wherein said escrow program includes an interface for user voice log-in to access said escrow information and status of said real estate property transactions.

36. A system for providing accurate real-time access of real estate property transaction information and status via voice communicate networks, comprising the steps of:
a. a main system server having a software application adapted to communicate with said voice communication networks, said application including a title program that allows its users to obtain title information and status of their real estate property transactions through said voice communication networks; and
b. a database in communication with said main system server containing said title information and status of said real estate property transactions that is accessible over said voice communication networks.

37. The system of claim 36, further comprising an Internet based web browser and graphical user interface for accessing of said database over the Internet.

38. The system of claim 36, wherein said title program includes tools for searching detailed title information within said database of said real estate property transactions.

39. The system of claim 36, wherein said title program includes an interface for user voice log-in to access said title information and status of said real estate property transactions.
